(19) United States
(12) Patent Application Publication
(10) Pub. No.: US 2016/0166992 A1
(43) Pub. Date: Jun. 16, 2016

(54) DISTILLATION SYSTEM AND A METHOD OF OPERATING THE SAME

(71) Applicant: General Electric Company, Schenectady, NY (US)

(72) Inventor: Jens Ruetten, Munich (DE)

(21) Appl. No.: 14/568,693

(22) Filed: Dec. 12, 2014

(51) Int. Cl. B01D 61/36

(52) U.S. Cl. CPC B01D 61/366; B01D 61/364; B01D 2313/22; B01D 2319/04; B01D 2317/04; B01D 2313/26

(57) ABSTRACT

A distillation system includes a first liquid inlet, a first liquid outlet, and a first membrane coupled to the first liquid inlet and the first liquid outlet, the first membrane being impermeable to a first liquid mixture and permeable to a gas. The distillation system further includes a first gas inlet and a first gas outlet fluidically coupled to the first gas inlet via the first membrane.

### BACKGROUND

The invention relates generally to distillation systems, and more particularly to a membrane based distillation system.

A fractionating column is used in distillation of liquid mixtures so as to separate the liquid mixtures into component parts, or fractions, based on the differences in volatilities. Fractionating columns may be used in small scale laboratory distillations as well as for large-scale industrial distillations. Fractionating columns are widely used in chemical process industries where large quantities of liquids have to be distilled. Such industries involve petroleum processing, petrochemical production, natural gas processing, coal tar processing, brewing, liquified air separation, hydrocarbon solvents production, and the like.

Fractionating columns used for lab scale distillation processes include a vigreux column or a straight column packed with glass beads or metal pieces such as raschig rings. In such a typical fractional distillation, a liquid mixture is heated in a distilling flask, and a resulting vapor rises up the fractionating column. Fractionating columns used for industrial scale distillation processes include bubble-cap “trays” or “plates” used to provide good contact between the upward flowing vapor and the downward flowing liquid inside the fractionating column. The vapor condenses on glass spurs (referred to as trays or plates) inside the column. At steady-state conditions, the vapor and liquid on each tray reach an equilibrium condition.

For certain industrial applications, a packing material is used in the column instead of trays, especially when low pressure drops across the column are required, such as when operating under vacuum conditions. The packing material may be either random dumped packing such as raschig rings or structured sheet metal. The packing material provides a large surface contact area between liquid and vapor phases. Liquids tend to wet the surface of the packing, and the vapors pass across the wetted surface affecting process efficiency.

There is a need for an enhanced distillation system.

### BRIEF DESCRIPTION

In accordance with one exemplary embodiment, a distillation system is disclosed. The distillation system includes a first liquid inlet, a first liquid outlet, and a first membrane coupled to the first liquid inlet and the first liquid outlet, the first membrane being impermeable to a first liquid mixture and permeable to a gas. The distillation system further includes a first gas inlet and a first gas outlet fluidically coupled to the first gas inlet via the first membrane.

In accordance with another exemplary embodiment, a system is disclosed. The system includes a distillation system having a first liquid inlet, a first liquid outlet, and a first membrane coupled to the first liquid inlet and the first liquid outlet, the first membrane being impermeable to a first liquid mixture and permeable to a gas. The distillation system further includes a first gas inlet and a first gas outlet fluidically coupled to the first gas inlet via the first membrane. The system further includes a condenser coupled to the first gas outlet, a pump coupled to the condenser and the first liquid inlet, and a boiler coupled to the first liquid outlet and the first gas inlet.

In accordance with yet another exemplary embodiment, a method is for operating a distillation system is disclosed. The method involves feeding a liquid mixture comprising a first liquid having a first volatility and a second liquid having a second volatility different from the first volatility, to a first liquid inlet. The method further involves feeding the liquid mixture along a first direction from the first liquid inlet to a first membrane, the first membrane being impermeable to the first liquid mixture. The method also involves feeding a gas along a second direction opposite to the first direction, from a first gas inlet to contact the first membrane, the first membrane being permeable to the gas. The method further involves separating at least a first portion of the second liquid from the liquid mixture by interacting the gas with the liquid mixture to generate a first depleted liquid mixture and an enriched gas. The method also involves feeding the depleted liquid mixture to a first liquid outlet and the enriched gas to a first gas outlet.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a system having an exemplary distillation system in accordance with an exemplary embodiment;

FIG. 2 is a schematic representation of an equilibrium stage of the distillation system in accordance with the embodiment of FIG. 1;

FIG. 3 is a schematic representation of a first equilibrium stage and a second equilibrium stage of a distillation system in accordance with another exemplary embodiment;

FIG. 4 is a schematic representation of an equilibrium stage of a distillation system in accordance with another exemplary embodiment;

FIG. 5 is a schematic representation of an equilibrium stage of a distillation system in accordance with another exemplary embodiment; and

FIG. 6 is a schematic representation of a first equilibrium stage and a second equilibrium stage of a distillation system in accordance with another exemplary embodiment.

### DETAILED DESCRIPTION

In accordance with certain embodiments of the present invention, a distillation system is disclosed. The distillation system includes a first liquid inlet, a first liquid outlet, and a first membrane coupled to the first liquid inlet and the first liquid outlet. The first membrane is impermeable to a first liquid mixture and permeable to a gas. The distillation system further includes a first gas inlet and a first gas outlet fluidically coupled to the first gas inlet via the first membrane. In accordance with another embodiment, a method for operating a distillation system is disclosed. The exemplary distillation system facilitates to separate different liquids having different volatilities from a mixture. A continuous concentration gradient can be achieved by the exemplary arrangement of a plurality of membranes.

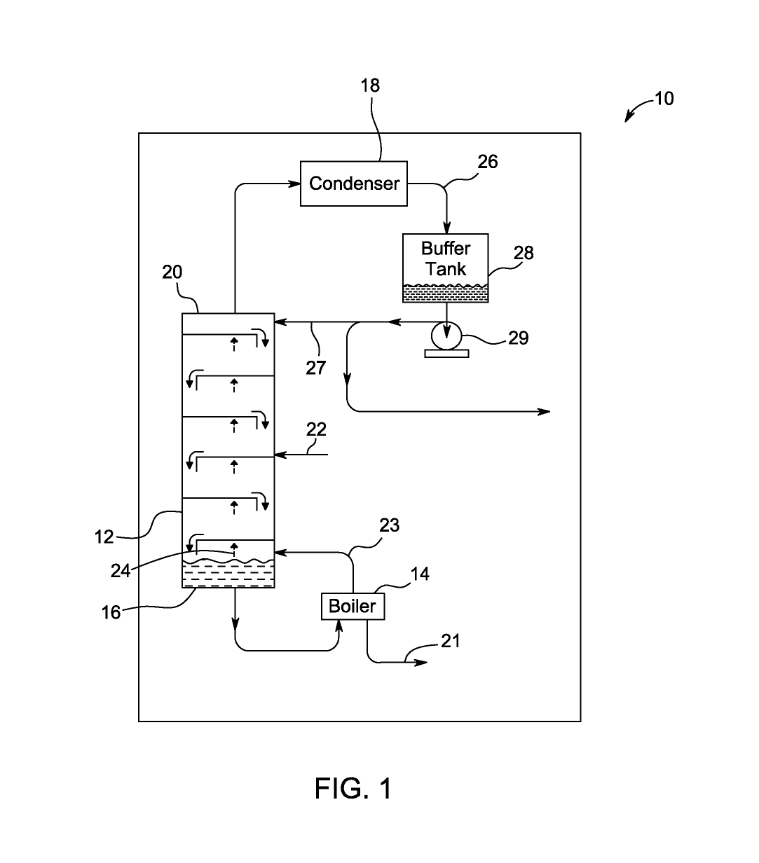

Referring to FIG. 1, a schematic representation of a system 10 in accordance with an exemplary embodiment is shown. The system 10 includes a distillation system 12, a boiler 14 coupled to one end 16 of the distillation system 12, a condenser 18 coupled to another end 20 of the distillation system 12. In the illustrated embodiment, the distillation system 12 is a membrane-based distillation system. A liquid mixture 22 enters a predefined stage of the distillation system 12. The predefined stage may vary depending on the application, for example, a feed concentration and a target concentration of the liquid mixture 22. The liquid mixture 22 includes a first liquid having a first volatility and a second liquid having a second volatility different from the first volatility. In the illustrated embodiment, the second volatility is higher than the first volatility. The distillation system 12 is configured to separate the first liquid from the second liquid, using a gas 24. The gas 24 is referred to as a gaseous phase of the liquid mixture 22. A composition of the gas 24 is dependent on an equilibrium state at a predefined stage in the distillation system 12. In one embodiment, the first liquid is water and the second liquid is ethanol. The liquid mixture 22 propagates downward through the distillation system 12 and in the process it is being depleted of the component with the higher volatility. It should be noted herein that the terms “second liquid”, “higher volatility component” may be used interchangeably.

During operation within the distillation system 12, the liquid mixture 22 is depleted of the higher volatility component (i.e. the second liquid) while the gas 24 is enriched with the higher volatility component due to reaction of the liquid mixture 22 with the gas 24. The gas 24 propagates upwards through the distillation system 12 and in the process is being enriched with the component of higher volatility. The concentration of the higher volatility component is gradually reduced from the end 20 to the end 16 of the distillation system 12. In other words, concentration of the higher volatility component in the liquid mixture 22 is a maximum proximate to the end 20 and a minimum proximate to the end 16 of the distillation system 12.

The first liquid exits from the end 16 to the boiler 14. A portion 21 of the first liquid is removed and a remaining portion 23 of the first liquid is vaporized within the boiler 14 to form a vapor 23. The vapor 23 is recirculated via the end 16 into the distillation system 12. The gas 24 enriched with the higher volatility component (in vapor form) exits via the end 20 to the condenser 18. The gas 24 enriched with the higher volatility component is condensed in the condenser 18 and a condensate 26 is fed to a buffer tank 28. A portion 27 of the condensate 26 is recirculated via the end 20 to the distillation system 12, using a pump 29. The structure and functioning of the distillation system 12 is explained in greater detail with reference to subsequent figures.

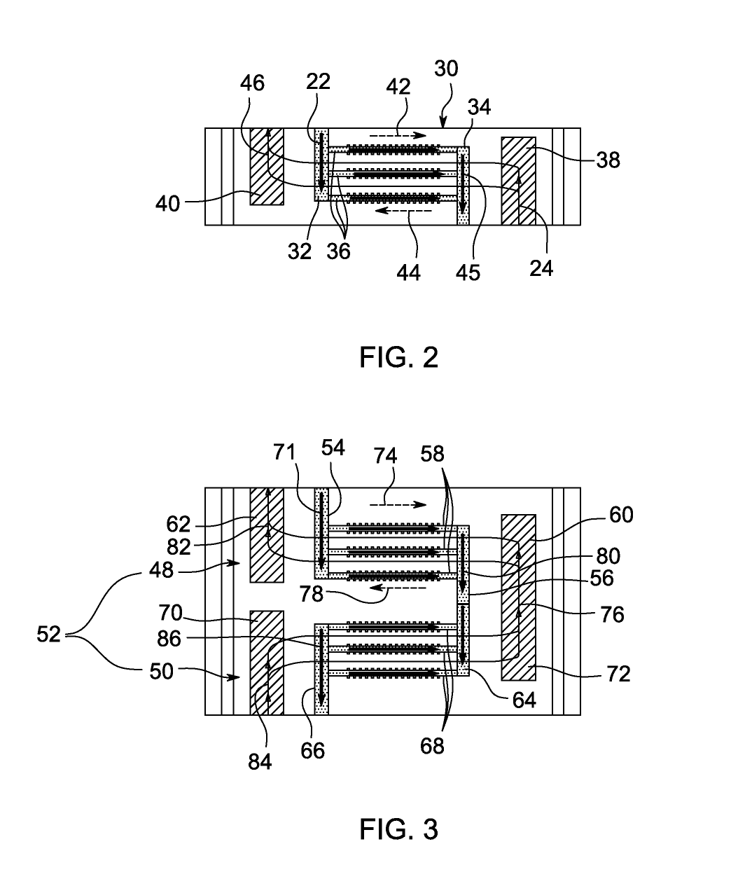

Referring to FIG. 2, a schematic representation of an equilibrium stage 30 of the distillation system 12 in accordance with the embodiment of FIG. 1 is shown. The equilibrium stage 30 includes a first liquid inlet 32, a first liquid outlet 34, and a plurality of first membranes 36 coupled to the first liquid inlet 32 and the first liquid outlet 34. Preferably, the plurality of first membranes 36 is disposed horizontally and parallel to each other. Further, the plurality of first membranes 36 is disposed orthogonally to the first liquid inlet 32 and the first liquid outlet 34. It should be noted herein that although three first membranes 36 are shown in the illustrated embodiment, in other embodiments, the number of first membranes 36 may vary depending upon the application. In one embodiment, only one first membrane 36 may be used. In another embodiment, two first membranes 36 may be used. In yet another embodiment, more than three first membranes 36 may be used. Further, in other embodiments, the orientation of the first membranes 36 may vary depending upon the application. For example, the first membranes 36 may be oriented vertically or at an inclined angle.

The “membrane” may be a hydrophobic or an oleophobic membrane, particularly a hydrophobic membrane. Composition of the membrane is not limited, and the membrane may be composed of polytetrafluoroethylene (PTFE), hydrophobic polyethersulfone or hydrophobic polycarbonate. In particular embodiments, membrane may be composed of expanded polytetrafluoroethylene (PTFE), more particularly, micro porous expanded PTFE. Such materials are commercially available, for example, from W.L. Gore & Associates.

In the illustrated embodiment, the equilibrium stage 30 further includes a first gas inlet 38 and a first gas outlet 40. The first gas outlet 40 is fluidically coupled to the first gas inlet 38 via the plurality of first membranes 36. It should be noted herein that the phrase “fluidically coupled” is referred to as gas flow from the first gas inlet 38 to the first gas outlet 40 either along the plurality of first membranes 36 or across the plurality of first membranes 36. Specifically, the condenser 18 coupled to the first gas outlet 40; the pump 29 is coupled to the condenser 18 and the first liquid inlet 32; and the boiler 14 is coupled to the first liquid outlet 34 and the first gas inlet 38.

During operation, the liquid mixture 22 having the first liquid with the first volatility and the second liquid with the second volatility different from the first volatility is fed to the first liquid inlet 32. It should be noted herein that the flow of the liquid through the distillation system 12 is preferably under the influence of gravity. Thereafter, the liquid mixture 22 is fed along a first direction 42 from the first liquid inlet 32 to the plurality of first membranes 36. The plurality of first membranes 36 is employed to provide a flow channel for the flow of the liquid mixture 22. The gas 24 is fed along a second direction 44 opposite to the first direction 42, from the first gas inlet 38 to contact the plurality of first membranes 36. In the illustrated embodiment, the gas 24 flows along the plurality of first membranes 36. The plurality of first membranes 36 prevents permeability of the liquid mixture 22 but allows permeability of the gas 24 to permit interaction of the gas 24 with the liquid mixture 22. As a result, a first portion of the second liquid is separated from the liquid mixture 22, to generate a first depleted liquid mixture 45 and an enriched gas 46. As the gas 24 and the liquid mixture 22 interact with each other in counterflow, the more volatile component (i.e. the first portion of the second liquid) is being enriched in the gas 24. Thereafter, the depleted liquid mixture 45 is fed to the first liquid outlet 34 and the enriched gas 46 is fed to the first gas outlet 40. Although one equilibrium stage of the distillation system 12 is shown in the illustrated embodiment, in other embodiments, the number of equilibrium stages may vary depending on the application.

Referring to FIG. 3, a schematic representation of a first equilibrium stage 48 and a second equilibrium stage 50 of a distillation system 52 in accordance with another exemplary embodiment is shown. The first equilibrium stage 48 includes a first liquid inlet 54, a first liquid outlet 56, and a plurality of first membranes 58 coupled to the first liquid inlet 54 and the first liquid outlet 56. The plurality of first membranes 58 is disposed horizontally and parallel to each other. Further, the plurality of first membranes 58 is disposed orthogonally to the first liquid inlet 54 and the first liquid outlet 56. It should be noted herein that although three first membranes 58 are shown in the illustrated embodiment, in other embodiments, the number of first membranes 58 may vary depending upon the application. Further, in other embodiments, the orientation of the first membranes 58 may vary depending upon the application.

In the illustrated embodiment, the first equilibrium stage 48 further includes a first gas inlet 60 and a first gas outlet 62. The first gas outlet 62 is fluidically coupled to the first gas inlet 60 via the plurality of first membranes 58.

The second equilibrium stage 50 includes a second liquid inlet 64, a second liquid outlet 66, a plurality of second membranes 68 coupled to the second liquid inlet 64 and the second liquid outlet 66. The plurality of second membranes 68 is disposed horizontally and parallel to each other. Further, the plurality of second membranes 68 is disposed orthogonally to the second liquid inlet 64 and the second liquid outlet 66. It should be noted herein that although three second membranes 68 are shown in the illustrated embodiment, in other embodiments, the number of second membranes 68 may vary depending upon the application. Further, in other embodiments, the orientation of the second membranes 68 may vary depending upon the application.

In the illustrated embodiment, the second equilibrium stage 52 further includes a second gas inlet 70 and a second gas outlet 72. The second gas outlet 72 is fluidically coupled to the second gas inlet 70 via the plurality of second membranes 68. The first liquid outlet 56 is coupled to the second liquid inlet 64 and the second gas outlet 72 is coupled to the first gas inlet 60.

During operation, the liquid mixture 71 having the first liquid with the first volatility and the second liquid with the second volatility different from the first volatility, is fed to the first liquid inlet 54. Thereafter, the liquid mixture 71 is fed along a first direction 74 from the first liquid inlet 54 to the plurality of first membranes 58. A gas 76 is fed along a second direction 78 opposite to the first direction 74, from the first gas inlet 60 to contact the plurality of first membranes 58. In the illustrated embodiment, the gas 76 flows along the plurality of first membranes 58. As a result, a first portion of the second liquid is separated from the liquid mixture 71, to generate a first depleted liquid mixture 80 and an enriched gas 82. Thereafter, the depleted liquid mixture 80 is fed to the first liquid outlet 56 and the enriched gas 82 is fed to the first gas outlet 62.

Further, the first depleted liquid mixture 80 is fed along the second direction 78 from the first liquid outlet 56 to the plurality of second membranes 68 via the second liquid inlet 64. A gas 84 is fed along the first direction 74, from the second gas inlet 70 to contact the plurality of second membranes 68. In the illustrated embodiment, the gas 84 flows along the plurality of second membranes 68. As a result, a second portion of the second liquid is separated from the first depleted liquid mixture 80, to generate a second depleted liquid mixture 86 and the gas 76 referred to as a first enriched gas. Thereafter, the second depleted liquid mixture 86 is fed to the second liquid outlet 66 and the first enriched gas 76 is fed to the first gas outlet 72. The first enriched gas 76 is fed from the first gas outlet 72 to the plurality of plurality of first membranes 58 via the first gas inlet 60. The enriched gas 82 is referred to as a second enriched gas.

In accordance with the exemplary embodiment, the plurality of equilibrium stages 48, 50 is stacked to separate liquids of larger concentration that may not be possible with a single equilibrium stage. Furthermore the exemplary modular arrangement allows flexibility, in which a primary feed can be introduced at a level of choice, and an external condenser, a reflux system, and a boiler can be adapted according to the system requirements.

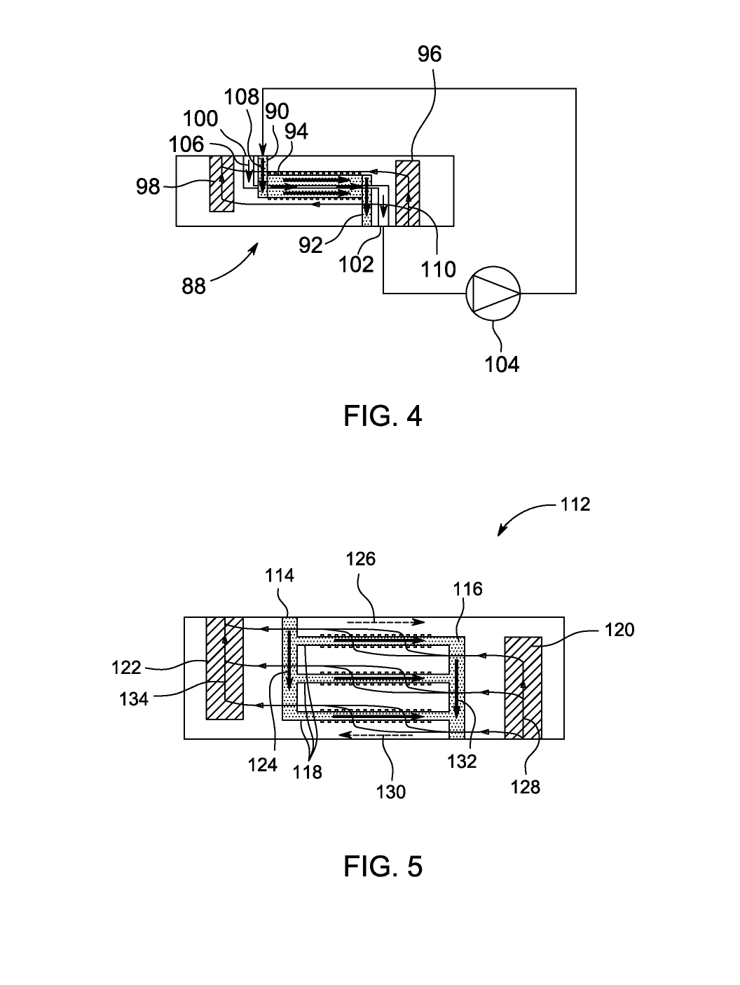

Referring to FIG. 4, a schematic representation of an equilibrium stage 88 of a distillation system in accordance with another exemplary embodiment. The equilibrium stage 88 includes a first liquid inlet 90, a first liquid outlet 92, and a first membrane 94 coupled to the first liquid inlet 90 and the first liquid outlet 92. The first membrane 94 is disposed horizontally and orthogonally to the first liquid inlet 90 and the first liquid outlet 92. In the illustrated embodiment, the equilibrium stage 88 further includes a first gas inlet 96 and a first gas outlet 98. The first gas outlet 98 is fluidically coupled to the first gas inlet 96 via the first membrane 94. In the illustrated embodiment, it should be noted herein that the phrase “fluidically coupled” is referred to as gas flow from the first gas inlet 96 to the first gas outlet 96 along the first membrane 94.

In the illustrated embodiment, additionally, a coolant channel 100 is disposed extending through the first membrane 94. An exit 102 of the coolant channel 100 is coupled to the first liquid inlet 90 via a coolant pump 104. It should be noted herein that the functioning of the equilibrium stage 88 is similar in function to the equilibrium stage 30 shown in FIG. 2.

In the illustrated embodiment, additionally, a coolant 106 is fed via the coolant channel 100 in heat exchange relationship with a liquid mixture 108. The liquid mixture 108 having a first liquid with the first volatility and a second liquid with the second volatility different from the first volatility is fed to the first membrane 94 via the first liquid inlet 90. The liquid mixture 108 and the coolant 106 are fed along the same direction (co-flow). The coolant 106 is fed via the coolant channel 100 to the first liquid inlet 90, using the coolant pump 104, to control a temperature of the liquid mixture 108. A gas 110 is fed from the first gas inlet 96 to contact the first membrane 94.

In the illustrated embodiment, a heat transfer occurs between the gas 110 and the liquid mixture 108 and then between the liquid mixture 108 and the coolant 106, thereby enabling generation of a temperature gradient along the first membrane 94.

Referring to FIG. 5, a schematic representation of an equilibrium stage 112 of a distillation system in accordance with another exemplary embodiment. The equilibrium stage 30 includes a first liquid inlet 114, a first liquid outlet 116, and a plurality of first membranes 118 coupled to the first liquid inlet 114 and the first liquid outlet 116. The plurality of first membranes 118 is disposed horizontally and parallel to each other. Further, the plurality of first membranes 118 is disposed orthogonally to the first liquid inlet 114 and the first liquid outlet 116.

In the illustrated embodiment, the equilibrium stage 112 further includes a first gas inlet 120 and a first gas outlet 122. The first gas outlet 122 is fluidically coupled to the first gas inlet 120 via the plurality of first membranes 118. In the illustrated embodiment, it should be noted herein that the phrase “fluidically coupled” is referred to as gas flow from the first gas inlet 120 to the first gas outlet 122 across the plurality of first membranes 118.

During operation, a liquid mixture 124 having a first liquid with a first volatility and a second liquid with a second volatility different from the first volatility is fed to the first liquid inlet 114. Thereafter, the liquid mixture 124 is fed along a first direction 126 from the first liquid inlet 114 to the plurality of first membranes 118. A gas 128 is fed along a second direction 130 opposite to the first direction 126, from the first gas inlet 120 to contact the plurality of first membranes 118. In the illustrated embodiment, the gas 128 flows across the plurality of first membranes 118 due to a pressure gradient generated across the plurality of first membranes 118. The gas 128 flows from a bottom side and exits from a top side of the plurality of membranes 118, while the membranes 118 are impermeable for the liquid mixture 124.

Specifically, the gas 128 permeates one membrane 118 of a pair of membranes; the liquid mixture 124 confined by the pair of membranes 118, then another membrane 118 of the pair of membranes, and so on. As a result, a first portion of the second liquid is separated from the liquid mixture 124, to generate a first depleted liquid mixture 132 and an enriched gas 134. As the gas 128 and the liquid mixture 124 interact with each other in counter flow, the more volatile component (i.e. the first portion of the second liquid) is being enriched in the gas 128. Thereafter, the first depleted liquid mixture 132 is fed to the first liquid outlet 116 and the enriched gas 134 is fed to the first gas outlet 122.

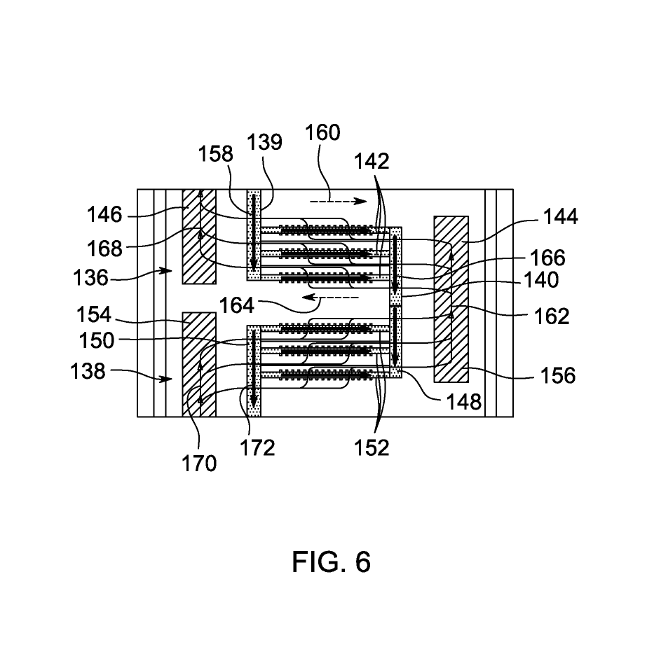

Referring to FIG. 6, a schematic representation of a first equilibrium stage 136 and a second equilibrium stage 138 of a distillation system in accordance with another exemplary embodiment is shown. The first equilibrium stage 136 includes a first liquid inlet 138, a first liquid outlet 140, and a plurality of first membranes 142 coupled to the first liquid inlet 138 and the first liquid outlet 140. The plurality of first membranes 142 is disposed horizontally and parallel to each other. Further, the plurality of first membranes 142 is disposed orthogonally to the first liquid inlet 138 and the first liquid outlet 140.

In the illustrated embodiment, the first equilibrium stage 136 further includes a first gas inlet 144 and a first gas outlet 146. The first gas outlet 146 is fluidically coupled to the first gas inlet 144 via the plurality of first membranes 142.

The second equilibrium stage 138 includes a second liquid inlet 148, a second liquid outlet 150, and a plurality of second membranes 152 coupled to the second liquid inlet 148 and the second liquid outlet 150. Preferably, the plurality of second membranes 152 is disposed horizontally and parallel to each other. Further, the plurality of second membranes 152 is disposed orthogonally to the second liquid inlet 148 and the second liquid outlet 150.

In the illustrated embodiment, the second equilibrium stage 138 further includes a second gas inlet 154 and a second gas outlet 156. The second gas outlet 156 is fluidically coupled to the second gas inlet 154 via the plurality of second membranes 152. The first liquid outlet 140 is coupled to the second liquid inlet 148 and the second gas outlet 156 is coupled to the first gas inlet 144.

During operation, a liquid mixture 158 having a first liquid with a first volatility and a second liquid with a second volatility different from the first volatility is fed to the first liquid inlet 138. Thereafter, the liquid mixture 158 is fed along a first direction 160 from the first liquid inlet 138 to the plurality of first membranes 142. A gas 162 is fed along a second direction 164 opposite to the first direction 160, from the first gas inlet 144 to contact the plurality of first membranes 142. In the illustrated embodiment, the gas 162 flows across the plurality of first membranes 142. As a result, a first portion of the second liquid is separated from the liquid mixture 158, to generate a first depleted liquid mixture 166 and an enriched gas 168. Thereafter, the depleted liquid mixture 166 is fed to the first liquid outlet 140 and the enriched gas 168 is fed to the first gas outlet 146.

Further, the first depleted liquid mixture 166 is fed along the second direction 164 from the first liquid outlet 140 to the plurality of second membranes 142 via the second liquid inlet 148. A gas 170 is fed along the first direction 160, from the second gas inlet 154 to contact the plurality of second membranes 152. In the illustrated embodiment, the gas 170 flows across the plurality of second membranes 152. As a result, a second portion of the second liquid is separated from the first depleted liquid mixture 166, to generate a second depleted liquid mixture 172 and the gas 162 referred to as a first enriched gas. Thereafter, the second depleted liquid mixture 172 is fed to the second liquid outlet 150 and the first enriched gas 162 is fed to the first gas outlet 146. The first enriched gas 162 is fed from the first gas outlet 146 to the plurality of plurality of first membranes 142 via the first gas inlet 144. The enriched gas 168 is referred to as a second enriched gas.

In accordance with the embodiments discussed herein, a downward flowing liquid phase is continuously depleted of a more volatile species, which in turn is enriched in a vapor phase via the exemplary equilibrium stages of the distillation system. As a result, opposing concentration gradients are generated in the liquid phase and the vapor phase leading to a higher degree of separation of the two species. The exemplary equilibrium stages provide a large surface area for interaction of a liquid phase and a vapor phase at a minimal flow resistance.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A distillation system comprising:
a first liquid inlet,
a first liquid outlet;
a first membrane coupled to the first liquid inlet and the first liquid outlet, the first membrane being impermeable to a first liquid mixture and permeable to a gas;
a first gas inlet; and
a first gas outlet fluidically coupled to the first gas inlet via the first membrane.

2. The distillation system of claim 1, wherein the first membrane comprises a plurality of first membranes disposed horizontally and parallel to each other, wherein the plurality of first membranes is disposed orthogonally to the first liquid inlet and the first liquid outlet.

3. The distillation system of claim 1, wherein the first liquid inlet, the first liquid outlet, the first membrane, the first gas inlet and the first gas outlet form a first equilibrium stage.

4. The distillation system of claim 3, further comprising a second equilibrium stage comprising:
a second liquid inlet,
a second liquid outlet;
a second membrane coupled to the second liquid inlet and the second liquid outlet;
a second gas inlet; and
a second gas outlet fluidically coupled to the second gas inlet via the membrane.

5. The distillation system of claim 4, wherein the first liquid outlet is coupled to the second liquid inlet and the second gas outlet is coupled to the first gas inlet.

6. The distillation system of claim 4, wherein the second membrane comprises a plurality of second membranes disposed horizontally and parallel to each other, wherein the plurality of second membranes is disposed orthogonally to the second liquid inlet and the second liquid outlet.

7. The distillation system of claim 1, further comprising a coolant channel extending through the first membrane.

8. The distillation system of claim 7, further comprising a coolant pump, wherein the coolant channel is coupled to the first liquid inlet via the coolant pump.

9. A system comprising:
a distillation system comprising:
a first liquid inlet,
a first liquid outlet;
a first membrane coupled to the first liquid inlet and the first liquid outlet, the first membrane being impermeable to a first liquid mixture and permeable to a gas;
a first gas inlet; and
a first gas outlet fluidically coupled to the first gas inlet via the first membrane;
a condenser coupled to the first gas outlet;
a pump coupled to the condenser and the first liquid inlet; and
a boiler coupled to the first liquid outlet and the first gas inlet.

10. The system of claim 9, wherein the first membrane comprises a plurality of first membranes disposed horizontally and parallel to each other, wherein the plurality of first membranes is disposed orthogonally to the first liquid inlet and the first liquid outlet.

11. The system of claim 9, wherein the first liquid inlet, the first liquid outlet, the first membrane, the first gas inlet and the first gas outlet form a first equilibrium stage.

12. The system of claim 11, wherein the distillation system further comprises a second equilibrium stage comprising:
a second liquid inlet,
a second liquid outlet;
a second membrane coupled to the second liquid inlet and the second liquid outlet;
a second gas inlet; and
a second gas outlet fluidically coupled to the second gas inlet via the second membrane.

13. The system of claim 12, wherein the first liquid outlet is coupled to the second liquid inlet and the second gas outlet is coupled to the first gas inlet.

14. The system of claim 12, wherein the second membrane comprises a plurality of second membranes disposed horizontally and parallel to each other, wherein the plurality of second membranes is disposed orthogonally to the second liquid inlet and the second liquid outlet.

15. A method for operating a distillation system, the method comprising:
feeding a liquid mixture comprising a first liquid having a first volatility and a second liquid having a second volatility different from the first volatility, to a first liquid inlet,
feeding the liquid mixture along a first direction from the first liquid inlet to a first membrane, the first membrane being impermeable to the first liquid mixture;
feeding a gas along a second direction opposite to the first direction, from a first gas inlet to contact the first membrane, the first membrane being permeable to the gas;
separating at least a first portion of the second liquid from the liquid mixture by interacting the gas with the liquid mixture to generate a first depleted liquid mixture and an enriched gas; and
feeding the depleted liquid mixture to a first liquid outlet and the enriched gas to a first gas outlet.

16. The method of claim 15, further comprising feeding the liquid mixture along the first direction from the first liquid inlet to the first membrane comprising a plurality of first membranes disposed horizontally and parallel to each other.

17. The method of claim 15, further comprising:
feeding the first depleted liquid mixture along the second direction from the first liquid outlet to a second membrane via a second liquid inlet;
feeding a first gas along the first direction from a second gas outlet to contact the second membrane;
separating at least a second portion of the second liquid from the first depleted liquid mixture by interacting the first gas with the first depleted liquid mixture to generate a second depleted liquid mixture and a first enriched gas; wherein the gas comprises the first enriched gas; and
feeding the second depleted liquid mixture to a second liquid outlet and the first enriched gas to the first gas inlet via a second gas outlet; wherein the enriched gas comprises a second enriched gas.

18. The method of claim 17, further comprising feeding the first depleted liquid mixture along the first direction from the first liquid outlet to the second membrane comprising a plurality of second membranes disposed horizontally and parallel to each other.

19. The method of claim 15, further comprising feeding a coolant via a coolant channel extending through the first membrane, in heat exchange relationship with the liquid mixture.

20. The method of claim 19, further comprising feeding the coolant via the coolant channel to the first liquid inlet, using a coolant pump, to control a temperature of the liquid mixture.

21. The method of claim 19, wherein feeding a gas comprises feeding the gas along the first membrane.

22. The method of claim 15, wherein feeding a gas comprises feeding the gas across the first membrane.
